(19) United States
(12) Patent Application Publication
(10) Pub. No.: US 2012/0173615 A1
(43) Pub. Date: Jul. 5, 2012

(54) DATA BROKER METHOD, APPARATUS AND SYSTEM

(75) Inventors: Kevin Glen Roy Greer, Mississauga (CA); Daniel Raymond MacDonald, Brampton (CA)

(73) Assignee: REDKNEE INC., Mississauga, ON (CA)

(21) Appl. No.: 13/394,259

(22) PCT Filed: Sep. 4, 2009
(86) PCT No.: PCT/CA2009/001229

§ 371 Date: Mar. 5, 2012

(51) Int. Cl. G06F 15/16

(52) U.S. Cl. 709/203

(57) ABSTRACT

A data broker method, apparatus and system is provided. The data brokerage system comprising: a profile server for executing a profile services application a native application format; a data broker engine connected to the profile server and configured to receive a data operation request from the profile services application in the native application format; one or more Data Sources connected to the data broker engine having specific formats different from each other and different from the native application format; the data operation request associated with the development and maintenance of the one or more Data Sources; the data broker engine configured to map the data operation request from the native application format, the specific formats corresponding to data maintained by those Data Sources and to received returned results of the data operation request from the Data Sources and to map the returned results into the native application format; and the data broker engine further configured to return the native application format returned results to the profile server.

### FIELD

The present specification relates generally to management of data that is electronically distributed across a plurality of Data Sources, such as is commonly found in telecommunication networks and other computing applications.

### BACKGROUND

It is known for telecommunication infrastructure to maintain electronic data objects (whether maintained in volatile or non-volatile storage) associated with mobile electronic devices that are provisioned to communicate via that telecommunication infrastructure. Such electronic data objects are often maintained in a different Data Sources with different protocols, formats, and data structures. Those Data Sources can also change over time and require high availability. Applications which access these different Data Sources are therefore extremely complex to program and maintain, greatly hampering the development of such applications. Applications which provide these Data Sources can also be complex to program. Applications tightly coupled to schemes/protocols are time consuming and troublesome to migrate/evolve and adapt to new business requirements—often introducing another independent Data Source is easier then integrating.

### SUMMARY

An aspect of the specification provides a data brokerage system comprising an application server for executing an application in its initial format. The system also comprises a data broker engine connected to the application server and configured to receive a data operation request from the application in the initial format. The initial format can be “native” to the application itself, or it can be composed. In an example embodiment, the system also comprises at least two Data Sources connected to the data broker engine having specific formats different from each other and different from the native application format. Although the data operation request is normally associated with at least two Data Sources, those skilled in the art will recognize that the data operation request can also be associated with one Data Source in a non-limiting scenario. The data broker engine is configured to map the data operation request from the native application format the specific formats corresponding to data maintained by those Data Sources. The data broker engine is configured to receive returned results of the data operation request from the Data Sources and to map the returned results into the native application format. The data broker engine is further optionally configured to return the native application format returned results to the application server.

It should be understood that application server can apply to any type of platform or computing environment, including another server or client machine such as a mobile device.

Those skilled in the art will recognize that in an alternative non-limiting configuration there could be only one data-source and its format could be the same as the application's.

The data broker engine can be further configured to maintain a cache of the returned results.

Another aspect of the present specification comprises a data brokerage method comprising:

receiving a data operation request from an application executing in an application server; the data request operation received in a native application format;

mapping the data operation request from the native application format to a plurality of specific formats corresponding to one or more Data Sources; each of the Data Sources maintaining data relevant to the data operation request; each of the Data Sources having specific formats different from each other and different from the native application format;

performing the data operation request in the specific formats at the one or more Data Sources;

receiving results of the data operation request in the specific formats returned from the one or more Data Sources;

mapping the returned results from the specific formats into the native application format; and,

forwarding the returned results in the native application format to the application in the application server.

### BRIEF DESCRIPTION OF THE DRAWINGS

FIG. 1 shows a schematic representation of a data broker system.

FIG. 2 shows a schematic representation of a computing environment that can be used to implement the various computing elements in the system of FIG. 1.

FIG. 3 shows a variation of the data broker system of FIG. 1.

FIG. 4 shows a flowchart depicting a data brokerage method.

FIG. 5 shows a variation of the data broker system of FIG. 1.

FIG. 6 shows a variation of the data broker system of FIG. 1.

### DETAILED DESCRIPTION OF THE EMBODIMENTS

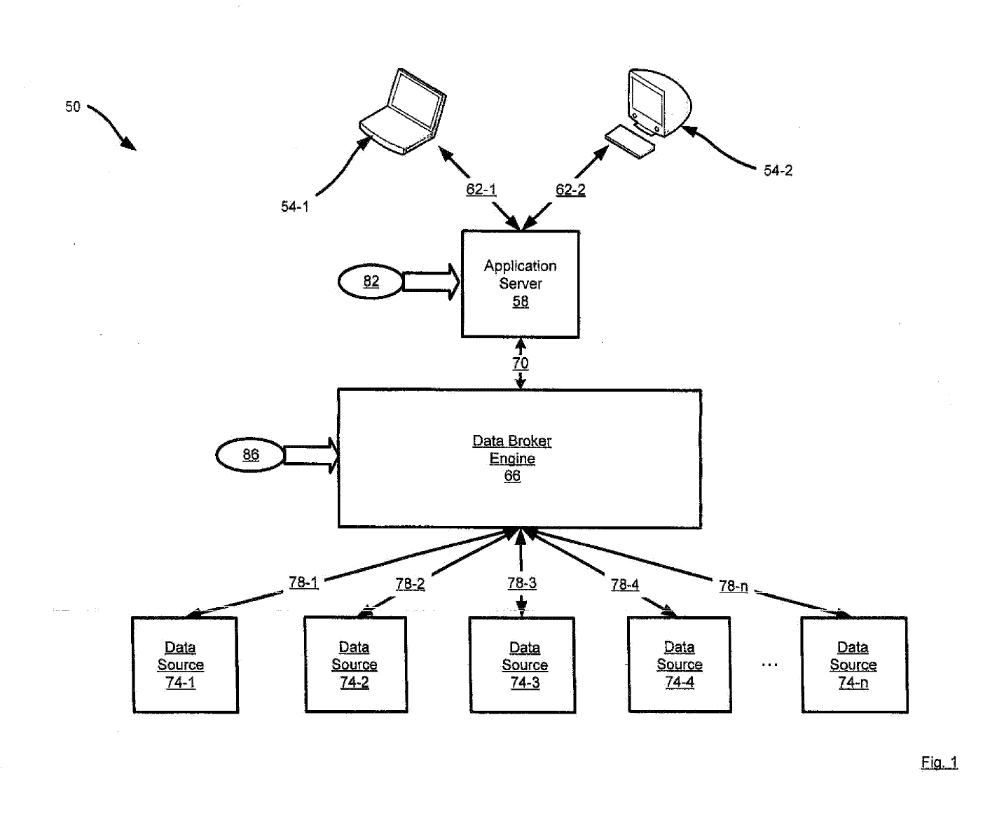

Referring now to FIG. 1, a data broker system is indicated generally at 50. System 50 comprises a plurality of client machines 54-1, 54-2 (generically, client machine 54, and collectively, client machines 54. This nomenclature is used elsewhere herein). Client machine 54-1 is connectable to at least one application server 58 via a first link 62-1, and client machine 54-2 is connectable to application server 58 via a second link 62-2.

Links 62 can be based on any type of infrastructure or combinations of infrastructures with any desired combination of layers according to, for example, the Open Systems Interconnect (OSI) reference model. As a simple example, links 62 can be an Internet connection. Each link 62 can also be different. For example, link 66-1 can be an Internet link, while link 62-2 can be an Intranet link. Other example infrastructures for links 62 will now occur to those skilled in the art.

Application server 58 is connectable to a data broker engine 66 via a third link 70. Third link 70, like links 62, can also be based on any type of infrastructure or combinations of infrastructures. Those skilled in the art will recognize that in a non-limiting embodiment that the link 70 is optional or virtual as the data broker engine 66 can be embedded into the application server 58.

Data broker engine 66 is in turn connectable to a plurality of Data Sources 74 via a plurality of Data Source links 78. Those skilled in the art will recognize that in a non-limiting embodiment that the Data Source links 78 are optional or virtual as one or more Data Sources 74 can be embedded within the data broker engine 66.

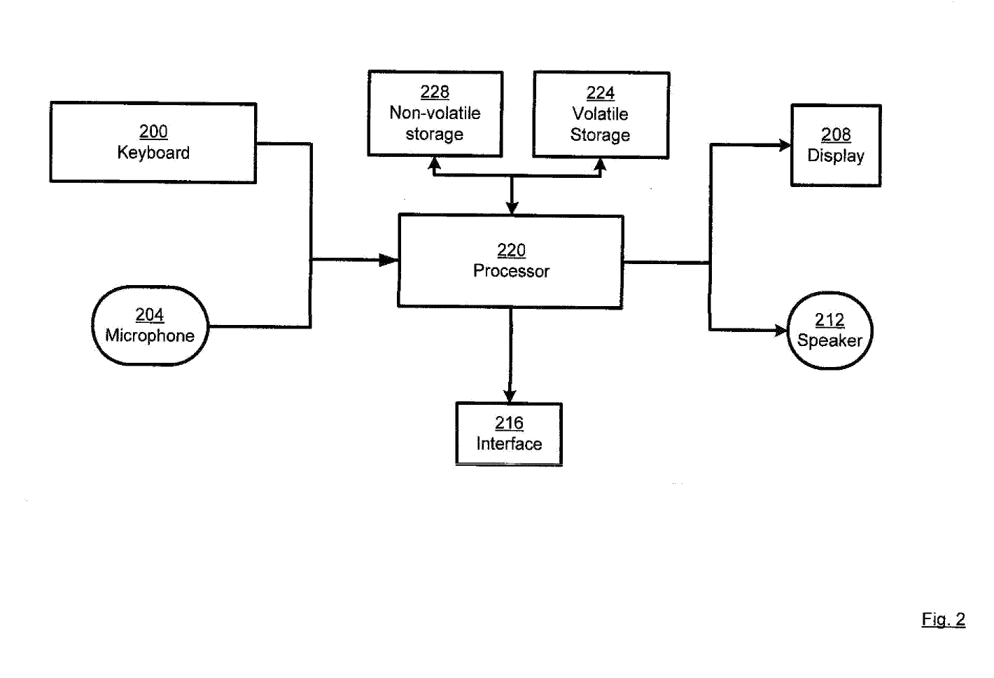

Referring briefly to FIG. 2, an exemplary structure for each of the computing elements in FIG. 1 is shown in greater detail. (The term “computing elements” refers to, in FIG. 1, clients 54, application server 58, data broker engine 66 and Data Sources 74). FIG. 2 is intended to describe a generic computing environment that could be used to implement each of those computing elements. Thus, each element can include one or more input devices in the form of a keyboard 200, microphone 204 and the like; one or more output devices in the form of a display 208, a speaker 212 and the like. Each computing element can also includes at least one interface 216, which can be used to establish connections via the various links associated with computing element. The foregoing components are interconnected by a microcomputer comprised of one or more central processing units 220 connected to volatile memory 224 (e.g. random access memory) and non-volatile memory 228 (e.g. FLASH memory, hard disc drive(s), redundant array of inexpensive disc(s) (RAID)).

It is to be noted that each computing element in FIG. 1 can itself be distributed or clustered. Likewise various elements can be combined into a single computing environment. It can also be noted that the not all of the computing elements in FIG. 1 may require the same types of input devices and/or output devices and/or volatile storage devices. Typically, client machines 54 would include a full set of input device and output devices, while application server may omit certain input devices and output devices. Those skilled in the art will now recognizes that which components shown in FIG. 2 are employed for various computing elements in FIG. 1 can be selected according to the context of the computing element in FIG. 1.

In a present embodiment with two or more Data Sources 74, it is contemplated that at least two of the Data Sources 74 are of a different type from each other. In common implementations, more than two of the Data Sources 74 are different from each other. Likewise, the links 78 for those different Data Sources can (though need not be) different from each other. Such links 78 tend to correspond to the specifications of their respective Data Sources 74. Data sources 74 can also change over time in a manner that is independent from changes to an application 82 that executes on application server 58.

Data sources 74 can therefore be databases or data servers or any other source of data that may be accessed by application 82. Exemplary Data Sources 74, and their respective links 78, can therefore be based on, for example, Structured Query Language (SQL) Databases, Lightweight Directory Access Protocol (LDAP) Data Sources, eXtended Markup Language (XML), Simple Object Access Protocol (SOAP), Common Object Request Broker Architecture (CORBA). The Data Source could also be another data broker engine. Other types of Data Sources 74 and corresponding respective links 78 will now occur to those skilled in the art. Indeed, a further example of a Data Source 74 includes the Data Source described in US Patent Publication 2008-0235255, “Extensible Data Repository”.

Data engine 66 is configured to execute at least one adapter application 86 that is configured to provide a schema and rules that maps data maintained in Data Sources 74 to data fields used in application 82. It should be understood that schema adaptation is optional. While schema adaptation is a powerful feature of the data broker, value can also be realized on the other capabilities of the engine 66. As will be explained in greater detail below, adapter application 86 is structured so that application 82 can be written (or otherwise configured) independently from the variations across the differing Data Sources 74, and independent of changes to Data Sources 74, while still providing application 82 with access to the data found across Data Sources 74.

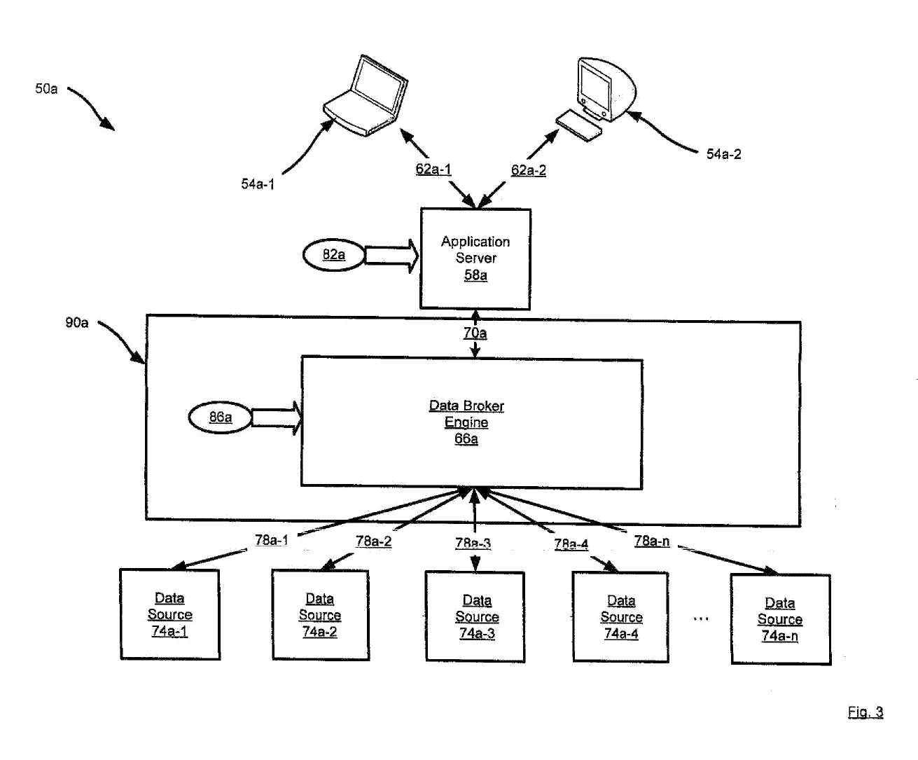

FIG. 3 shows system 50a, which is a variation of system 50 in FIG. 1. System 50a includes elements which are the same as elements in system 50, and thus like elements in system 50a bear the same reference to their counterparts in system 50, except followed by the suffix “a”. In system 50a, at least some of the Data Sources 74a are typically linked in some manner, such that data in a first Data Source 74a references at least data in a second Data Source. System 50a contemplates incorporating data broker engine 66a within a profile server in a telecommunication environment, such as the profile servers discussed co-pending application PCT/CA2007/001570, “Method and System for Active Profile Server”. System 50a thus also contemplates any type of application 82a that may be configured to access profile server 90a, and Data Sources 74a comprise any collection of Data Sources that maintain subscriber profile data.

Those skilled in the art will now appreciate that a wide variety of application servers 58a and applications 82a can be configured to access profile server 90a. A non-limiting example of such an application 82a is a location query application, whereby a client machine 54a can be operated to access application 82a and attempt to query the location of a mobile telephone device associated with a subscriber of a telephony network that is associated with profile server 90a. Application 82a has a native format that corresponds to the programming language and other aspects of the computing environment of server 58a. For example, assume that server 58a is a web-server so that queries from clients 54a are received via an Internet connection that characterizes links 62a and 70a. Application 82a is thus a web-application that is written in Hypertext markup language (HTML) and Java, and is configured to receive a name (e.g. “John Smith”) of a given subscriber from a client machine 54a, and, to access Data Sources 74a via broker engine 66a, and, if certain validations occur, then to return the location of that subscriber to the requesting client machine 54a. Table I shows exemplary profile data that may be stored across disparate Data Sources 74a which would be accessed by such an exemplary location query application 82a.

TABLE I
Data Source 74a-1
Common Attributes to Data Source 74a-1:
Data Source Type: SQL Database
Link Type: JDBC/SQL

| Entry | Name | MSISDN | IMSI |
|---|---|---|---|
| 1 | Robert Smith | 403 235 1234 | 310150123456789 |
| 2 | John Doe | 204 585 5396 | 310150123489078 |
| 3 | John Doe | 204 674 3462 | 310150123498743 |

TABLE 2
Data Source 74a-2
Common Attributes to Data Source 74a-2:
Data Source Type: Client Proprietary Subscriber Permissions Database
Link Type: LDAP Version 3

| | | | | Client |
|---|---|---|---|---|
| | | Client Permissions = | Client Permissions = | Permissions = |
| Entry | IMSI | Always Allow | Allow with Query | Always Deny |
| 1 | 310150123456789 | Application Taxi_Finder, | Null Entry | All Not in |
| | | Application Friend_Finder | | Allow or Allow |
| | | | | with Query |
| | | | | List |
| 2 | 310150123489078 | Application | Null Entry | All Not in |
| | | Weather_Channel, | | Allow or Allow |
| | | Application | | with Query |
| | | Regional_Road_Conditions | | List |
| 3 | 310150123498743 | Application | Application | Application |
| | | Weather_Channel, | Local_Entertainment | Friend_Finder |
| | | Application | | |
| | | Restaurant_Locator | | |
| 4 | Default | Null Entry | All | Null Entry |

TABLE 3
Data Source 74a-3
Common Attributes to Data Source 74a-3:
Data Source Type: Client Proprietary Application Attribute Database
Link Type: CORBA

| | | | Field - |
|---|---|---|---|
| | | | Required |
| | | Field - | Location |
| Entry | Field - Application | Application Class | Resolution |
| 1 | Taxi_Finder | Information | Cell/Sector |
| 2 | Friend_Finder | Social | 100 Meters |
| | | Networking | |
| 3 | Weather_Channel | Information | Cell/Sector |
| 4 | Regional_Road_Conditions | Information | Cell/Sector |
| 5 | Restaurant_Locator | Information | 100 Meters |
| 6 | Local_Entertainment | Entertainment | Cell/Sector |
| 7 | 911 | Emergency | Maximum |
| | | | Accuracy |
| 8 | Homeland_Security | National Security | Maximum |
| | | | Accuracy |
| 9 | FBI | National Security | Maximum |
| | | | Accuracy |

TABLE 4
Data Source 74a-4
Common Attributes to Data Source 74a-4:
Data Source Type: Location Gateway
Link Type: Mobile Location Protocol 3.2.0

| | | Field - Required Location | |
|---|---|---|---|
| Entry | Field - IMSI | Resolution | Field - Location |
| 1 | Dynamic (IMSI | Dynamic | Dynamic |
| | Format) | | |

TABLE 5
Data Source 74a-5
Common Attributes to Data Source 74a-5:
Data Source Type: Client Proprietary Regional Regulatory Permissions
Database
Link Type: SOAP/XML

| | | Field - | | |
|---|---|---|---|---|
| | Field - | Geodetic | Field - Application | Field - Regulatory |
| Entry | Location | Boundary | Class | Permissions |
| 1 | Dynamic | United States | National Security | Always Permit |
| 2 | Dynamic | United States | Emergency | Always Permit |
| 3 | Dynamic | Nevada | Social Networking | Always Permit |
| 4 | Dynamic | California | Social Networking | Query if not in |
| | | | | Client Permission |
| | | | | list |
| 5 | Dynamic | Postal Code | ALL | Always Permit |
| | | 90210 | | |
| 6 | Dynamic | Salt Lake | Application Friend | Always Deny |
| | | City | Finder | |
| | | Metropolitan | | |
| | | Serving Area | | |
| 7 | Dynamic | Default | ALL | Query if not in |
| | | | | Client Permission |
| | | | | list |

Table I which provides a non-limiting example of the input and output fields associated with Data Source 74a-1, will now be explained in greater detail. Data source 74a-1, which in this example is of the type SQLDatabase and link 78a-1 corresponding to Data Source 74a-1 is of the type JDBC/SQL. Data source 74a-1 as per Entry 1 links the name of an individual (Robert Smith) and Mobile Subscriber ISDN Number (MSISDN) (403 235 1234) with an International Mobile Subscriber Identity (IMSI) (310150123456789) associated with a particular mobile telephony device. Similarly, Data Source 74a-1 as per Entry 2 links the name of an individual (John Doe) and MSISDN (204 585 5396) with an IMSI (310150123489078) associated with a particular mobile telephony device. Similarly, Data Source 74a-1 as per Entry 3 links the name of an individual (John Doe) and MSISDN (204 674 3462) with an IMSI (310150123498743) associated with a particular mobile telephony device. Those skilled in the art will recognize that one or more input fields (or input vectors) can be indexed for the purpose of linking one or more output fields (or output vectors).

Table 2 which provides a non-limiting example of the input and output fields associated with Data Source 74a-2, will now be explained in greater detail. Data source 74a-2, which in this example is of the type ‘Client Proprietary Subscriber Permissions Database’ and link 78a-2 corresponding to Data Source 74a-2 is of the type LDAP Version 3. Data source 74a-2 as per Entry 1 links the IMSI retrieved from Data Source 74a-1 to a set of defined location-query permissions as defined by the subscriber as prescribed via the following fields: Client Permissions=Always Allow; Client Permissions=Allow with Query; and Client Permissions=Always Deny. Thus, the entries of Data Source 74a-2 contemplates that the named subscriber from Data Source 74a-1 has certain permissions associated with which third parties may, may with a confirmation query to the device, or may not, make inquiries as to the location of the telephony device having the IMSI belonging to that subscriber and MSISDN. Such permissions might include, for example, an express indication that a query from a service application hosted on client machine 54a-1 is permitted (or permitted upon an explicit confirmation query to the device) to ascertain the location of the subscriber via application 82a, while a query from an application hosted on client machine 54a-2 is not permitted to ascertain the location of the subscriber via application 82a. The field Client Permissions=Always Allow lists the applications that a given device (as identified via an IMSI) is allowed to access without an explicit confirmation query to the subscriber. The field Client Permissions=Allow with Query lists the applications that a given device (as identified via an IMSI) is allowed to access with an explicit confirmation query to the subscriber. The field Client Permissions=Always Deny lists the applications that a given device (as identified via an IMSI) is not allowed to access. Data source 74a-2 as per Entry 1 links the IMSI (310150123456789) of a device with Application Taxi_Finder and Application Friend_Finder per the Client Permissions Always Allow field and indicates that there are no explicitly listed applications which require a query and all other applications should be disallowed from accessing the location of the device. Similarly, Data Source 74a-2 as per Entry 2 links the IMSI (310150123489078) of a device with Application Weather_Channel and Application Regional_Road_Conditions per the Client Permissions Always Allow field and indicates that there are no explicitly listed applications which require a query and all other applications should be disallowed from accessing the location of the device. Similarly, Data Source 74a-2 as per Entry 3 links the IMSI (310150123498743) of a device with Application Weather_Channel and Application Restaurant_Locator per the Client Permissions Always Allow field; indicates that the Application Local_Entertainment should result in an explicit confirmation query to the device; and indicates that the Application Friend_Finder should always be denied access. Similarly, Data Source 74a-2 as per Entry 4 provides a default result in the event that there is no entry for a given IMSI. In one non-limiting example of a query to Data Source 74a-2 with an IMSI of 310150123498743 and Application Weather_Channel would return a result of Client Permissions=Always Allow.

Table 3 which provides a non-limiting example of the input and output fields associated with Data Source 74a-3, will now be explained in greater detail. Data source 74a-3, which in this example is of the type ‘Client Proprietary Application Attribute Database’ and link 78a-3 corresponding to Data Source 74a-3 is of the type CORBA. Data source 74a-3 as per Entry 1 links the name of an application (Taxi_Finder) with a Application Class field (Information) and a Required Location Resolution Field (Cell/Sector). Similarly, Data source 74a-3 as per Entry 2 links the name of an application (Friend_Finder) with a Application Class field (Social Networking) and a Required Location Resolution Field (100 Meters). Similarly, Data source 74a-3 as per Entry 3 links the name of an application (Weather_Channel) with a Application Class field (Information) and a Required Location Resolution Field (Cell/Sector). Similarly, Data source 74a-3 as per Entry 4 links the name of an application (Regional_Road_Conditions) with a Application Class field (Information) and a Required Location Resolution Field (Cell/Sector). Similarly, Data source 74a-3 as per Entry 5 links the name of an application (Restaurant_Locator) with a Application Class field (Information) and a Required Location Resolution Field (100 Meters). Similarly, Data source 74a-3 as per Entry 6 links the name of an application (Local_Entertainment) with a Application Class field (Entertainment) and a Required Location Resolution Field (Cell/Sector). Similarly, Data source 74a-3 as per Entry 7 links the name of an application (911) with a Application Class field (Emergency) and a Required Location Resolution Field (Maximum Accuracy). Similarly, Data source 74a-3 as per Entry 8 links the name of an application (Homeland_Security) with a Application Class field (National Security) and a Required Location Resolution Field (Maximum Accuracy). Similarly, Data source 74a-3 as per Entry 9 links the name of an application (FBI) with a Application Class field (National Security) and a Required Location Resolution Field (Maximum Accuracy). In one non-limiting example of a query to Data Source 74a-3 with an Application equal to Weather_Channel would return a result of Application Class=Information and Required Location Resolution=Cell/Sector.

Table 4 which provides a non-limiting example of the input and output fields associated with Data Source 74a-4, will now be explained in greater detail. Data source 74a-4, which in this example is of the type ‘Location Gateway’ and link 78a-4 corresponding to Data Source 74a-4 is of the type Mobile Location Protocol 3.2.0. Data source 74a-4 as per Entry 1 links the name of a dynamic IMSI field and a dynamic Required Location Resolution field to a dynamic Location field. In one non-limiting example of a query to Data Source 74a-4 with IMSI equal to 310150123456789 and a Required Location Resolution Field equal to Cell/Sector would retrieve one or more geodetic parameters that provides the ascertained location associated with the IMSI in a manner that is compliant with Mobile Location Protocol 3.2.0 and that complies with the requested location resolution. Thus Data Source 74a-4 is linked to a location service, which is configured to ascertain the particular location of a given IMSI using for example, time delay of arrival triangulation (TDOA) techniques from base stations in communication with the telephony device of the given IMSI, or to query an global positioning system (GPS) chipset that is onboard the given telephony device. Thus, entry 1 contemplates that the named subscriber from Data Source 74a-1 has certain permissions associated with which third parties may, or may not, make inquiries as to the location of the telephony device having the IMSI belonging to that subscriber. Such permissions might include, for example, an express indication that a query from a service application hosted on client machine 54a-1 is permitted to ascertain the location of the subscriber via application 82a, while a query from service application hosted on client machine 54a-2 is not permitted to ascertain the location of the subscriber via application 82a.

Table 5 which provides a non-limiting example of the input and output fields associated with Data Source 74a-5, will now be explained in greater detail. Data source 74a-5, which in this example is of the type ‘Client Proprietary Regional Regulatory Permissions Database’ and link 78a-5 corresponding to Data Source 74a-5 is of the type SOAP/XML. Data source 74a-5 links a given ascertained location from Data Source 74a-4 to a set of defined location-query permissions as defined by the current legal jurisdiction in which the telephony device associated with the IMSI is actually located. Thus, Data Source 74a-5 contemplates that the legal jurisdiction where telephony device having the IMSI from Data Source 74a-1 may include privacy legislation that restricts whether or not application 82a is permitted to ascertain the location of any telephony device within that particular jurisdiction. As a specific non-limiting example, Data Source 74a-5 as per entry 1 links a dynamic location field to a Geodetic Boundary field (United States) and Application Class field (National Security) with a Regulatory Permissions field (Always Permit). Similarly, Data source 74a-5 as per entry 2 links a dynamic location field to a Geodetic Boundary field (United States) and Application Class field (Emergency) with a Regulatory Permissions field (Always Permit). Similarly, Data source 74a-5 as per entry 3 links a dynamic location field to a Geodetic Boundary field (Nevada) and Application Class field (Social Networking) with a Regulatory Permissions field (Always Permit). Similarly, Data source 74a-5 as per entry 4 links a dynamic location field to a Geodetic Boundary field (California) and Application Class field (Social Networking) with a Regulatory Permissions field (Query if not in Client Permission list). Similarly, Data source 74a-5 as per entry 5 links a dynamic location field to a Geodetic Boundary field (Postal Code 90210) and Application Class field (ALL) with a Regulatory Permissions field (Always Permit). Similarly, Data source 74a-5 as per entry 6 links a dynamic location field to a Geodetic Boundary field (Salt Lake City Metropolitan Serving Area) and Application Class field (Application Friend_Finder) with a Regulatory Permissions field (Always Deny). Similarly, Data source 74a-5 as per entry 7 provides a default linkage between a given location and applications or application classes that are not explicitly addressed by the other entries in Data Source 74a-5 and a default Regulatory Permissions entry (Query if not in Client Permissions list). In one non-limiting example of a query to Data Source 74a-5 with the location ascertained to be somewhere in Vermont and an Application Class=Information would return a result of Regulatory Permissions=Query if not in Client Permission list.

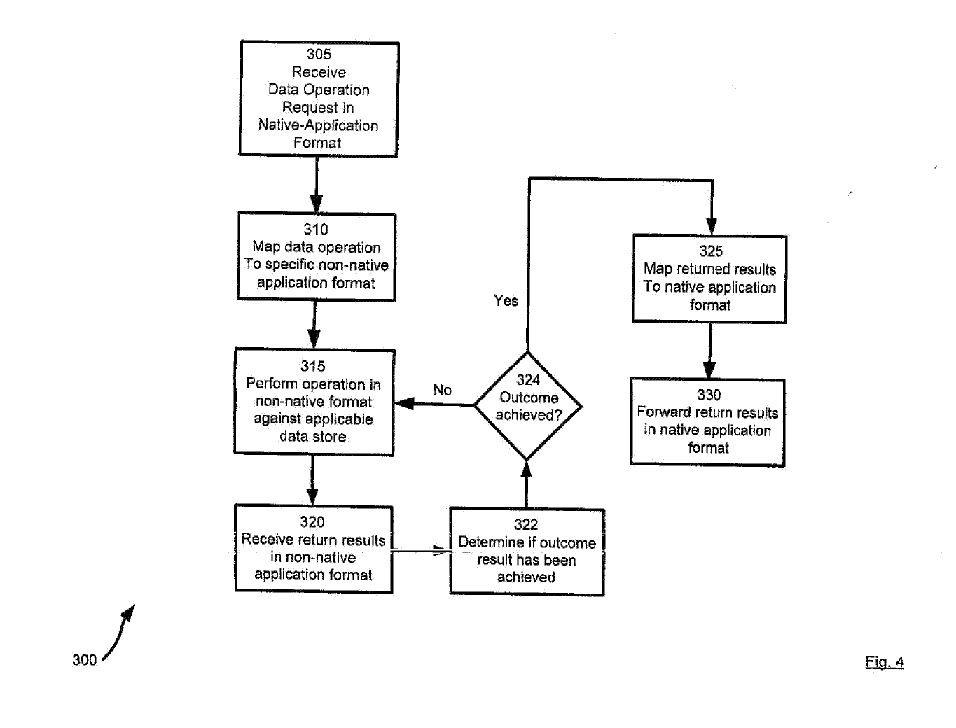

Referring now to FIG. 4, a flowchart depicting a data brokerage method is indicated generally at 300. Method 300 can be implemented using system 50, or system 50a. To assist in explaining method 300, method 300 will be explained in reference to system 50a and the specific example above relative to Tables 1-5 and application 82a. Method 300 can be performed by adapter application 86a at engine 66a. Block 305 comprises receiving a data operation request in a native-application format. In the present example, the data operation is a request for a location for a subscriber of a particular name and MSISDN. Block 305 is performed at data broker engine 66a, which receives the name of a given subscriber and MSISDN, in association with a request for the location of that subscriber, in a format native to HTML, Java and the Internet via link 70a. (Block 305 thus presupposes that a subscriber's name and MSISDN has been received at application 82a from a client 54a). It should now be understood that the term “format” is used in a non-limiting sense, to encompass one or more of levels of the OSI reference model associated with link 70a and application 82a.

Block 310 comprises mapping the data operation from block 305 into a specific non-native format. The specific non-native format corresponds with the Data Source(s) 74a that are relevant to the data operation from block 305. Adapter application 86a is configured to provide a schema that maps the request and data provided by application 82a to a request to Data Source 74a-1 using the Name and MSISDN fields to retrieve an IMSI.

Block 315 comprises the retrieval of one or more data records via a query according to the input fields determined via adaptation application 86a. According to Table I, the name of a subscriber and MSISDN is mapped to a specific IMSI within Data Source 74a-1, and so the request from block 305 is mapped into the format associated with the Data Source Type and Link Type per Table 1. In a non-limiting example, data broker engine 66a, per the schema and rules provided by adapter application 86a, initiates a query with Name=John Doe and MSISDN=204 674 3462.

Block 320 comprises the receipt of one or more data records via a query response according to the response fields determined via adaptation application 86a. In a non-limiting example, data broker engine 66a, per the schema and rules provided by adapter application 86a, receives an IMSI=310150123498743.

Block 322-324 comprises the determination if the outcome per the data operation request received in Block has been achieved. Data broker engine 66a, per the schema and rules provided by adapter application 86a, makes a determination if the outcome has been achieved. If the data broker engine 66a, per the schema and rules provided by adaptor application 86a, determines that the requested outcome (as received by the application server 56a in block 305) has not been achieved, then the process returns to block 315. The data broker engine 66a, per the schema and rules provided by adapter application 86a can retrieve one or more data records via a query according to the input fields determined via adaptation application 86a from a given Data Source 74a-N. If the requested outcome (as received by the application server 56a in block 305) has been achieved, then the process continues to Block 325.

For the non-limiting example as described by Tables 1, 2, 3, 4, and 5, the data broker engine, per the schema and rules provided by adaptor application 86a, may undertake the following data retrieval and mapping process: (i) Subsequent to the retrieval of the IMSI via Data Source 74a-1 per Table 1, the Data Source engine will use the IMSI as an input field to retrieve the device permissions from Data Source 74a-2. In a non-limiting example, data broker engine 66a, per the schema and rules provided by adapter application 86a, receives an Client Permissions Always Allow=Yes given the input fields of IMSI=310150123498743 and Application=Weather_Channel; (ii) Subsequent to the retrieval of the Client Permissions field via Data Source 74a-2 per Table 2, the Data Source engine will use Application parameter as an input field to retrieve the Application Class and Required Location Resolution attributes from Data Source 74a-3. In a non-limiting example, data broker engine 66a, per the schema and rules provided by adapter application 86a, receives a Application Class=Information and Required Location Resolution=Cell/Sector given the input field of Application=Weather_Channel; (iii) Subsequent to the retrieval of the Application Class and Required Location Resolution fields via Data Source 74a-3 per Table 3, the Data Source engine will use the IMSI and required Location Resolution fields as an input fields to retrieve the ascertained location from Data Source 74a-4 per Table 4. In a non-limiting example, data broker engine 66a, per the schema and rules provided by adapter application 86a, receives an ascertained location given the input field of IMSI=310150123498743 and Required Location Resolution=Cell/Sector; (iv) Subsequent to the retrieval of the ascertained location via Data Source 74a-4 per Table 4, the Data Source engine will use the ascertained location (retrieved from Data Source 74a-4) and the Application Class (retrieved from Data Source 74a-3) as input fields to retrieve the Regulatory Permissions from Data Source 74a-4 per Table 5. In a non-limiting example assuming that the ascertained location is within the state of Vermont, United States, data broker engine 66a, per the schema and rules provided by adapter application 86a, receives a Regulatory Permissions=Query if not in Client Permissions list given the input filed of the ascertained location (within the state of Vermont, United States) and an Application Class=Information (as retrieved from Data Source 74a-3). The data broker engine 66a, per the schema and rules provided by adaptor application 86a, determines that the requested response (as received in Block 305) has been achieved. To summarize, IMSI is in turn linked to a specific location in Data Source 74a-4, and permissions in Data Source 74a-2, and regulatory permissions in Data Source 74a-5, and each of those Data Sources has their own specific format (i.e., in this example Data Source Type and Link Type) as indicated in Table 2 and Table 5 respectively. Thus, blocks 315-324 comprises performing the operation from block 305 in the specific non-native format(s) mapped at block 310, and block 320 comprises receiving results for that operation in the specific non-native format(s).

Block 325 comprises mapping the returned results to the native application format. Thus, in the present example, the ascertained location information per Table 4 from Data Source 74a-4 is mapped back to the native formats associated with application 82a, which in the present example is HTML, Java and the Internet via link 70a. Block 330 comprises forwarding those mapped results back to the requesting application in the native format of that application. Having returned those results, application 82a can then utilize the data retrieved from Data Source 74a-4 to ascertain whether or not the actual location from Field 2 of Entry 3 should be returned to the requesting client 54a. If “yes”, then application 82a can return the location back to the requesting client 54a, and if “no”, then application 82a can send a reply indicating a refusal to send a response to such a request.

Those skilled in the art will recognize that the data broker engine, per the schema and configured rules or provided through an adapter application 86a, can access one or more Data Sources in any sequence as well as perform operations against applicable Data Sources more than once or not as all depending on the nature of the request received at block 305.

Those skilled in the art will now recognize that other types of applications, other than the location query application 82a, can also be configured to operate with system 50 or system 50a. As a first example, a varied application 82a can be an authentication application that authenticates whether a particular client machines 54a (or user of that client machine 54a) is permitted to access data on Data Source 74a. This can be useful particularly where one or more Data Sources 74a do not have formats that are conducive or otherwise suitable for authentication operations. Those skilled in the art will now appreciate that such an authentication application is a simplified version of location query application 82a.

As a second example, a varied application 82a can be an encryption application that encrypts data between server 58a and clients 54a over link 62a, and thereby permits access of data on Data Sources 74a over link 62a where link 62a would otherwise be susceptible to eavesdropping. This can be useful particularly where one or more Data Sources 74a do not have formats that are conducive or otherwise suitable for encryption operations.

As a third-example, a varied application 82a can be a simple white-list/black-list application that only permits access to certain Data Sources for certain client machines 54a, but not others. Thus client machine 54a-1 could be configured within application 82a to have access to Data Sources 74a, while client machine 54a-2 could be configured within application 82a to have be prevented from accessing Data Sources 74a.

As a fourth example, a varied application 82a can be a licensing application that permits access to different Data Sources 74a, or different portions thereof, for different client machines 54a or users of those machines 54a.

As a fifth example, a varied application 82a can be a throttling application that limits bandwidth, or caps access of different Data Sources 74a for different client machines 54a or users of those machines 54a. A throttling application could thus permit client machine 54a-1 to access Data Sources 74a at one bit rate, while permitting client machine 54a-2 to access Data Sources 74a at another bit rate.

As a sixth example, a varied application 82a can be a logging application that tracks the access patterns of various client machines 54a (or users at those client machines 54a) Data Sources 74a. Such logging could then be used for auditing purposes to ascertain whether access of such Data Sources 74a complied with applicable regulations.

As a seventh example, a varied application 82a can be a performance monitoring application that ascertains the “uptime” at various client machines 54a (or users at those client machines 54a), relative to the ability to successfully access various Data Sources 74a.

Still further examples of such other applications include auditing applications, caching applications, filtering applications, data source or data element augmenting applications, data source element substituting applications, fault injection applications, time delay applications.

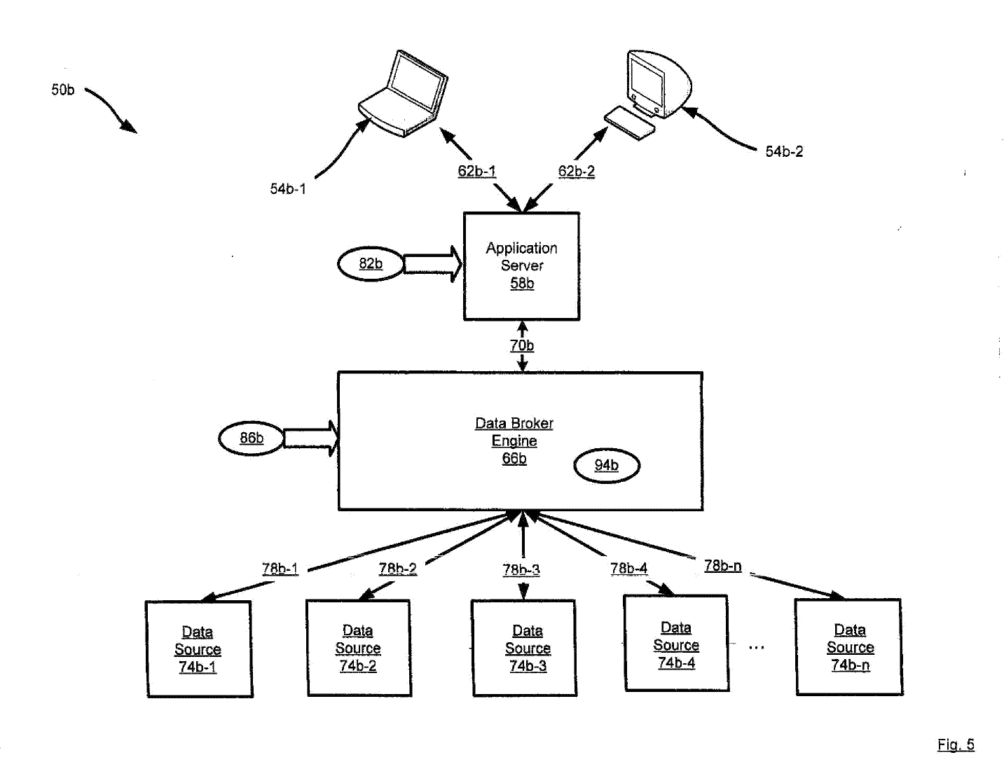

FIG. 5 shows system 50b, which is a variation of system 50 in FIG. 1. System 50b includes elements which are the same as elements in system 50, and thus like elements in system 50b bear the same reference to their counterparts in system 50, except followed by the suffix “b”. Of note is that system 50b includes a cache 94b within engine 66b. Cache 94b is configured to periodically access one or more Data Sources 74b and maintain an image of relevant data on sources 74b locally within engine 66b. Typically cache 94b is configured to access data as required on and need not be proactive. Thus, when method 300 is performed, access can be made directly to cache 94b rather than individually accessing sources 74b. Such caching can be performed to reduce resource burdens of repeated requests on a given Data Source 74b. Such caching can also be performed to reduce latencies that are caused by Data Source 74b that has the greatest latency when accessed.

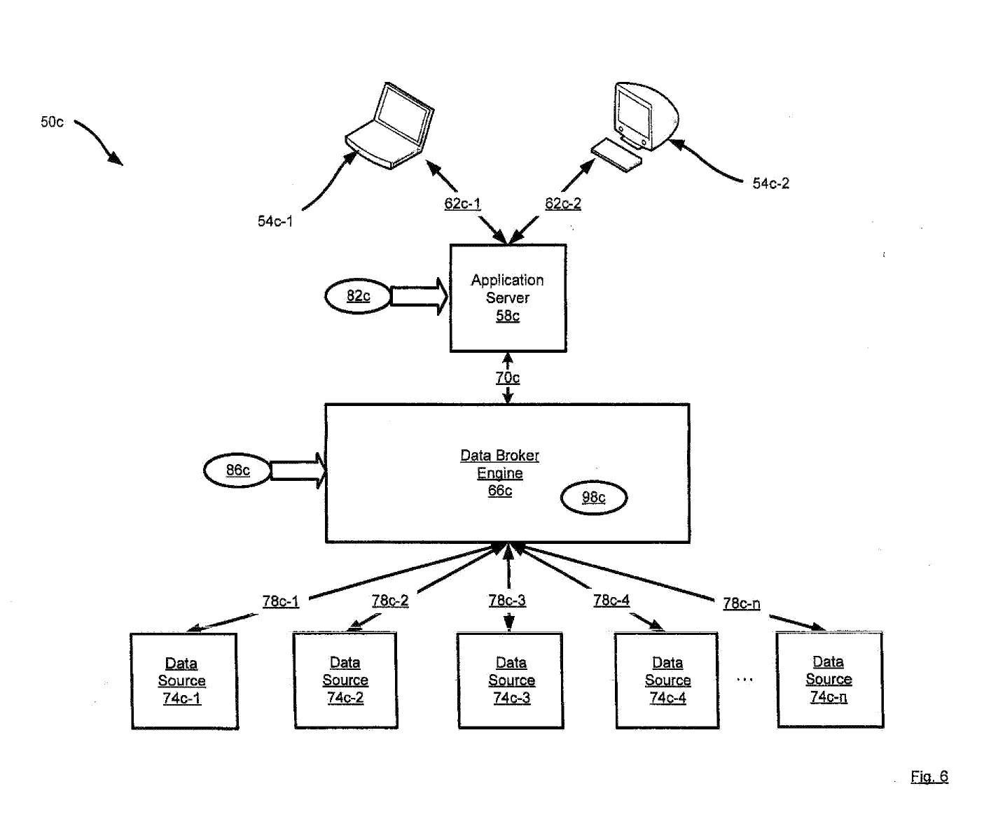

FIG. 6 shows system 50c, which is a variation of system 50 in FIG. 1. System 50c includes elements which are the same as elements in system 50, and thus like elements in system 50c bear the same reference to their counterparts in system 50, except followed by the suffix “c”. Of note is that system 50c includes a load balancing application 98c within engine 66b. In system 50c, it is assumed that two or more Data Sources 74c provide the same function. (For example account balance information for a given user population for use in a high-availability embodiment of the disclosure.). Load balance application 98c is configured to periodically access Data Sources 74b that perform the same function and determine which of those Data Sources 74b should be utilized during performances of method 300, in order to balance the resource demand load between those Data Sources 74b that perform the same function. By the same token, load balance application 98c can be modified to act as a partition application so as to spread a single data function across multiple Data Sources 74b.

Various unexpected advantages will now occur. For example, the teachings herein can be used to provide a single point of protocol conversion, whereby application 82a can be used to convert data from various Data Sources 74a into a single desired protocol. As another example, as new Data Sources 74a are connected to engine 66a, or are disconnected from engine 66a, application 82a can remain unaffected such that only adapter application 86a need be modified, thereby freeing the developer of application 82a to focus on the functionality of application 82a rather than the complexities and problems associated with making data connections to disparate Data Sources 74a. As another example, application 82a can be migrated or updated without concern for the complexities and problems associated with making data connections to disparate Data Sources 74a. Those skilled in the art will recognize that large portions of applications to transform manipulate and make decisions on data can be integrated in the data broker tier.

Combinations, variations and subsets of the foregoing are contemplated.

1. A data brokerage system comprising:
an application server for executing an application in a native application format;
a data broker engine connected or embedded to said application server and configured to receive a data operation request from said application in said native application format;
one or more Data Sources connected to said data broker engine having specific formats different from each other and different from said native application format; said data operation request associated with said one or more Data Sources;
said data broker engine configured to map said data operation request from said native application format said specific formats corresponding to data maintained by those Data Sources; said data broker engine configured to received returned results of said data operation request from said Data Sources and to map said returned results into said native application format;
said data broker engine further configured to return said native application format returned results to said application server.

2. The data broker system of claim 1 wherein said data broker engine is further configured to maintain a cache of said returned results.

3. The data broker system of claim 1 wherein said application is an authentication application that authenticates whether access to data on said Data Sources is permitted.

4. The data broker system of claim 1 wherein said application is an encryption application that encrypts data between said application server and a client machine connected to said application server.

5. The data broker system of claim 1 wherein said application is a white-list/black-list application that only permits access to certain of said Data Sources for certain client machines that are connected to said application server

6. The data broker system of claim 1 wherein said application is a throttling application that either limits bandwidth or caps data accessed at said Data Sources.

7. The data broker system of claim 1 wherein said application is a logging application that tracks the access patterns of client machines that are connected to said application server and which access said Data Sources.

8. The data broker system of claim 1 wherein said application is a performance monitoring application that ascertains the uptime at various client machines that are connected to said application server.

9. A data broker engine in accordance with the data broker engine of claim 1.

10. A data brokerage method comprising:
receiving a data operation request from an application executing in an application server; said data request operation received in a native application format;
mapping said data operation request from said native application format to a plurality of specific formats corresponding to one or more Data Sources; each of said Data Sources maintaining data relevant to said data operation request;
each of said Data Sources having specific formats different from each other and different from said native application format;
performing said data operation request in said specific formats at said one or more Data Sources;
receiving results of said data operation request in said specific formats returned from said one or more Data Sources;
mapping said returned results from said specific formats into said native application format; and,
forwarding said returned results in said native application format to said application in said application server.
